(19) United States
(12) Patent Application Publication
(10) Pub. No.: US 2006/0088751 A1
(43) Pub. Date: Apr. 27, 2006

(54) Mobile device for supplying power by means of fuel cells

(76) Inventors: Manfred Stefener, Munchen (DE); Jens Muller, Munchen (DE); Oliver Freitag, Munchen (DE)

Correspondence Address: IP STRATEGIES, 12 1/2 WALL STREET, SUITE I, ASHEVILLE, NC, 28801, US

(21) Appl. No.: 10/506,143

(22) PCT Filed: Dec. 9, 2002
(86) PCT No.: PCT/EP02/13935

§ 371 Date: Feb. 23, 2005

(51) Int. Cl. H01M 8/02; H01M 2/10

(52) U.S. Cl. 429/34; 429/99; 429/100

(57) ABSTRACT

The present invention relates in general to mains-independent power supply and in particular to a housing for a mobile power supply device, wherein there are provided at least one housing section for accommodating at least one fuel cell device, at least one housing section for accommodating at least one electric consumer, and at least one housing section for installing a fuel tank or for insertion of a replaceable fuel cartridge.

### PRIOR ART

Not least in view of the increasing mobility of society and, in particular, of the business world, there is a high and constantly increasing demand for electric devices whose power demand can, fully or temporarily, be satisfied in a mains-independent manner.

The extremely wide field of use of mains-independent power supply means will be elucidated by the exemplary selection of fields of use, which follows hereinbelow and which is by no means exhaustive.

Camping and caravan, open air events, film shootings (in particular exterior shots), surveying, underwater work, technical emergency services (natural catastrophes), mining, field laboratories (e.g. meteorological stations), armed forces, civil and military aviation (e.g. reconnaissance drones and meteorological balloons), space aviation, and numerous kinds of sport and extreme sport, such as sailing, gliding, balloon trips.

Known examples of battery-driven electrical equipment are: entertainment electronics (“walkman”), mobile phones, satellite telephones, film cameras, laptops, accumulator-driven tools, such as drills, etc.

In many fields of use, a permanent power supply from the mains is impossible because mobility would be excessively restricted or because access to the mains is not possible at all, whereas in other fields of use it would be too dangerous, e.g. under water.

In the above-mentioned cases, power supply is normally effected by rechargeable batteries, so-called secondary elements, which are usually referred to as accumulators in everyday speech.

Such accumulators have two substantial drawbacks.

On the one hand, accumulators are normally charged via a mains-powered charging set. Although the accumulator need no longer be removed in many cases, this means, in the final analysis, that one is still dependent on the supply mains, the period required for charging being in many cases much longer than the discharge period of the accumulator.

On the other hand, the operating time of accumulator-driven electronic devices is normally limited to a few hours. In the case of notebooks and mobile phones this operating time lies, at present, in the range of a few hours. Another problem of accumulators is that, even if no current is consumed, they will discharge within a few weeks.

Most of these disadvantages are avoided in the case of power supply by means of fuel cells. However, most of the commercially available electrical units are configured for battery/accumulator operation and cannot be retrofitted for internal fuel cell operation without excessive expenditure and effort. The alternative, viz. power supply by an external fuel cell, is, however, considered to be not useful in practice for most applications, since the use of an electric unit with a separate power supply would normally impair the ease of use and would therefore, in the final analysis, also reduce the acceptance of such combined systems.

### DESCRIPTION OF THE INVENTION

It is the object of the present invention to provide devices by means of which the above-mentioned drawbacks of a mains-independent power supply can be avoided.

According to the present invention, this object is achieved by the housing for a mobile power supply device having the features according to claim 1, the mobile power supply device having the features according to claim 9, and the mobile power supply system having the features according to claim 13.

In the case of the housing for a mobile power supply device according to the present invention, there are provided at least one housing section for accommodating at least one fuel cell device, at least one housing section for accommodating at least one electric consumer, and at least one housing section for installing a fuel tank or for insertion of a replaceable fuel cartridge.

It follows that the electric consumers, the power supply device and the fuel stock can be transported and supplied with power within a housing and, at least partially, also used within said housing. In particular the accumulators of accumulator-driven consumers can be charged in a mains-independent manner and without any loss of mobility.

When fuel cartridges are used, it will be advantageous to provide a suitable interface in the housing with the aid of which connection and exchange of said fuel cartridges will practically be as easy, safe and convenient for the user as insertion and removal of a battery. This further development guarantees the highest possible degree of mobility. If a continuous operation is desired for which the capacity of one cartridge does not suffice, it is possible to provide either a reserve tank which supplies the device with fuel during the period of exchange, or connections for a plurality of (at least two) cartridges so that, in the case of an empty cartridge, the supply of fuel will be maintained by one or a plurality of cartridges that are not yet empty.

In the case of the further development described last, an external connection for a supply of fuel is not necessary. For devices which are mostly operated as stationary units and which are expected to be rarely moved, it may, however, be expedient to supply fuel predominantly from outside and to provide an exchangeable cartridge or a replenishable tank only as an interim solution and/or for guaranteeing a higher degree of mobility.

For this case, a further development is provided according to which the housing has a connection for supplying fuel from outside. This connection can be used for directly supplying fuel to the fuel cell, and it can also be used as an interim fuel supply during replacement of a fuel cartridge as well as for filling the tank. This further development is preferably used in cases where a good infrastructure for the supply of fuel is available, since it will then not be necessary to take the fuel stock along, or, if the fuel stock is taken along, it can be saved for situations in which external supply is impossible. In hydrogen- or methanol-driven vehicles, for example, additional connections for extracting fuel can easily be provided in the car interior.

This further development is also advantageous in cases where, for reasons of security, it is precarious to take along fuel. Also in the case of units which must be operated continuously in a mains-independent manner and without maintenance for very long periods of time (e.g. field laboratories), it will be more expedient to guarantee fuel supply via a big external tank which is connected to the unit in question than to provide a large stock within the mobile power supply device. If the whole fuel stock were provided in the form of an internal stock, this would determine the dimensions of the unit to a substantial extent in the case of long-term operation; from a certain necessary stock onwards, this would inevitably impair the mobility of the whole unit.

According to a specially preferred embodiment, the housing comprises at least one plug-in place for mounting an electric consumer. The plug-in place is preferably provided in the interior of the housing so that units connected thereto can easily be transported together with the device and protected by the housing of said device. It may, however, also be expedient to provide the plug-in places on the outer side of the housing; this is unproblematic, especially in the case of small devices.

Although a direct electric connection could be established between consumers and the respective outputs of the fuel cell, it will be advantageous to provide an electric interface in the housing, which is connected to the fuel cell (or fuel cells) on one side thereof and which allows connection of the at least one electric consumer on the other side thereof.

According to an advantageous further development, the plug-in places are formed integrally with an associated electric interface so that, when electrical equipment is mechanically connected, an electric connection will simultaneously be established as well. This will substantially increase the user friendliness of the device according to the present invention and the risk of operator errors will be reduced at the same time.

Preferably, the housing comprises an active security system and/or an active lock system, which serve the purpose of theft protection and allow only authorized persons to access the interior of the housing. Such systems are known from the field of technology; in the device according to the present invention, they can be used in a particularly advantageous manner, since they do not require any separate power supply, but can be supplied with power by the installed fuel cell(s) itself (themselves).

Particularly preferred shapes for the housing are the shape of a case or of a chest. Devices having these shapes can easily be carried by one person (or a few persons), they can be designed such that they do not take up much space and have good stability, and, if desired, they can be provided with wheels so as to facilitate transport. Many of the units to be supplied can be taken along within the case or the chest and, if necessary, removed therefrom simply and quickly.

According to a special further development, the housing additionally has electric interfaces on the outer surface of the housing. These interfaces may be simple connecting sockets (for power extraction), but, if desired, they may also be mechanical plug-in places with electric connection contacts.

In the case of connecting sockets, external consumers can be connected by means of power cables. In the second case, such cables are not required; this will be advantageous especially for frequently used small units, such as mobile phones.

The mobile power supply device according to the present invention comprises a housing of the nature described hereinbefore and at least one fuel cell device arranged in said housing. Fuel can be supplied by means of internal fuel supply (tank, cartridge) or external fuel supply.

An advantageous further development of the mobile power supply device comprises a control means, e.g. a microprocessor, for controlling the fuel supply of electric consumers connected to said power supply device. This control means is implemented (programmed) in such a way that it allows intelligent power management, which discerns the operating conditions of units connected thereto and controls the fuel supply of these units in accordance with a predeterminable hierarchy.

In the mobile power supply device according to the present invention, a direct methanol fuel cell is preferably used. This fuel cell has numerous advantages in comparison with other frequently used fuel cell types, which need not be specified here in detail. In comparison with the rival hydrogen technology, reference is specially made to the high storage density and the lower hazard potential of methanol (danger of explosion of hydrogen).

In many cases, absolute reliability of the power supply is, in addition to mobility, extremely important. In view of the fact that, in the case of fuel cell devices, fluid streams occur which depend to a greater (in the case of liquids) or to a lesser (in the case of gases) degree on an acceleration acting thereon from outside and especially on the direction of the gravity effect, there may be certain orientations of the fuel cell device in the case of which said device is not, or only to a limited extent capable of operating. For a mobile power supply device this may, of course, be a serious problem, especially in fields of use where the position of the housing changes often and in an unforeseeable manner and/or where varying external forces are involved.

It follows that, for such cases of use, the mobile power supply device must be configured such that it remains capable of operating in the case of all, or at least in the case of all probable positions of the housing (the probable positions of the housing are preferred positions that can be predetermined by the shape of the housing and the centre of gravity of the whole device).

For such cases of use, advantageous further developments of the mobile power supply device are therefore provided, in the case of which the housing is implemented such and the at least one fuel cell device is arranged in said housing such that the operability of the at least one fuel cell device is guaranteed in at least one stable preferred position of said housing, or wherein the at least one fuel cell device is arranged in the housing in such a way that it occupies a position having an orientation which depends on the position of the housing and which guarantees the operability of said fuel cell device at any position of the housing, or wherein a plurality of fuel cell devices is arranged in said housing such that the operability of at least one fuel cell device is guaranteed at any position of the housing.

The present invention additionally provides a mobile power supply system comprising at least one of the above-described mobile power supply devices and at least one distribution unit for connecting electric consumers, said distribution unit being connected to an electric interface of the at least one mobile power supply device via an external line.

The system can, for example, consist of a mobile power supply device according to the present invention, which serves exclusively the purpose of power supply, whereas the distribution unit connected to the power supply device serves exclusively the purpose of accommodating consumers and/or supplying power to said consumers.

For explaining the invention still further, preferred embodiments of the present invention will be described hereinbelow making reference to the figures enclosed, in which:

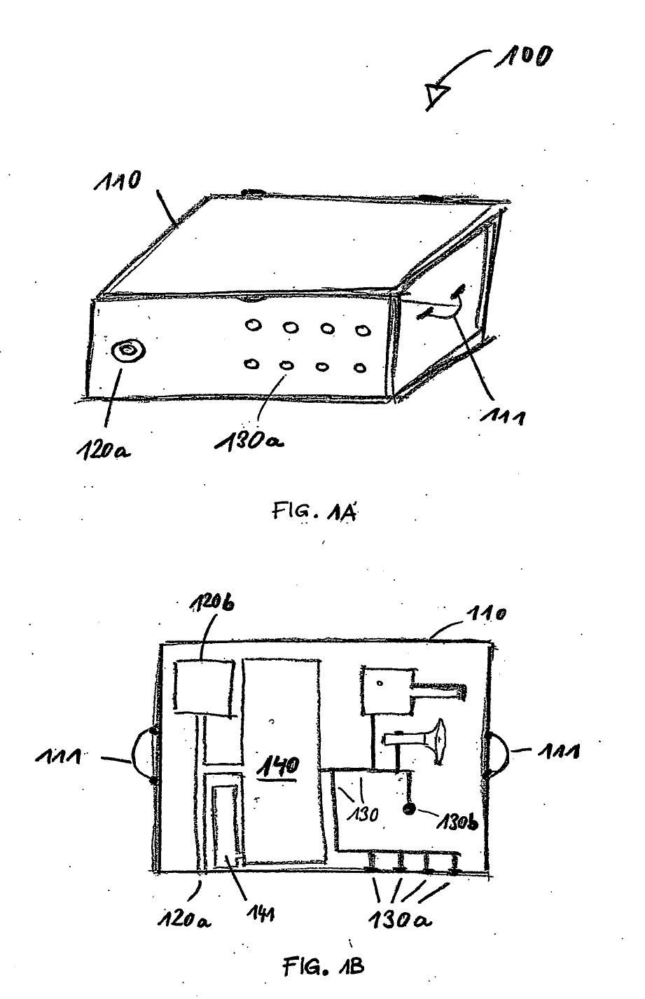

FIG. 1 shows a mobile power supply device having the shape of a chest;

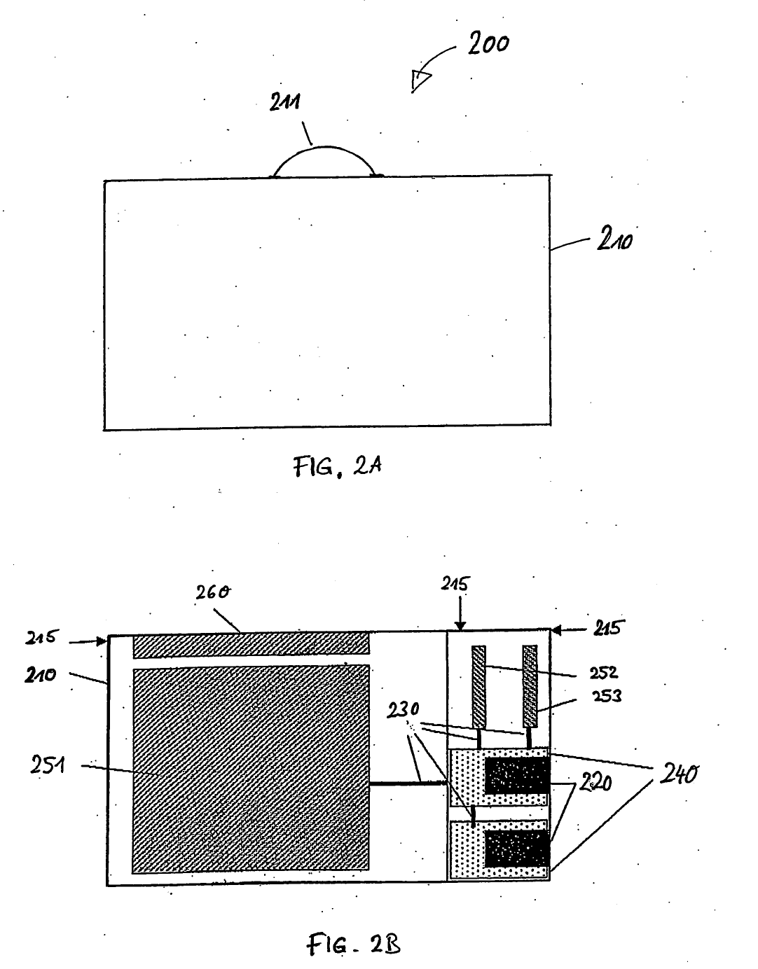

FIG. 2 shows a mobile power supply device having the shape of a case;

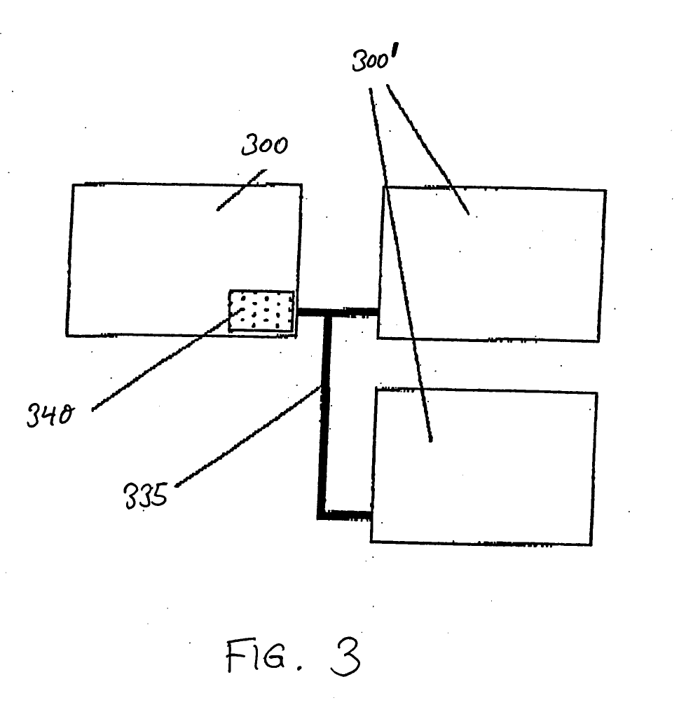

FIG. 3 shows a case system.

FIGS. 1A and 1B show a first preferred embodiment of the mobile power supply device 100 according to the present invention.

The device comprises a chestlike housing 110 having provided thereon lateral, hinged carrying handles 111. The housing 110 has a hinged cover which permits access to the interior of the chest. The outer front surface of the chest has provided thereon a connecting piece 120a for supplying fuel to the fuel cell 140 that is fixedly installed in the interior of the chest. This connecting piece 120a is provided with a non-return valve or with some other shut-off means so that an escape of fuel is prevented.

The front surface of the chest has additionally provided thereon a plurality of power supply sockets 130a which have connected thereto leads 130 from the fuel cell so as to allow connection of electric consumers.

Separate sockets can be provided for different output voltages.

Additionally or alternatively, different types of sockets 130a may also be provided for a certain voltage so that a plug connection can be established for various common plugs.

The interior view of the housing 110, which is shown in a top view in FIG. 1B, shows a schematic room layout which only serves as an illustration, but which should not be misinterpreted as true to scale.

In the interior of the chest a plug-in place 120b for a replaceable fuel cartridge is provided. It follows that, with the fuel cartridge installed, the device 100 can also be used for power supply without any fuel supply from outside being necessary.

According to an alternative embodiment, a fixedly installed reserve tank can be provided instead of the plug-in place 120b for a replaceable fuel cartridge, said reserve tank being filled automatically when fuel is supplied from outside and maintaining the operability of the device for a certain period of time when the supply of fuel from outside has been stopped.

In the interior of the chest, a plurality of connection places 130b is provided at which accumulator-driven consumers, in the example shown in the sketch a camera and a radiator, can be plugged in at specially provided or standardized plug-in places. These plug-in places are implemented such that the units in question are reliably held and that the accumulators provided in said units are simultaneously charged without any necessity of removing them from the respective consumers for this purpose.

Furthermore, an optional device 141 is shown in the sketch, which serves to accommodate or to filter reaction products of the fuel cell 140. This may, for example, be a small receptacle for collecting condensation water. Such a device is not necessary in cases in which the reaction products can easily be discharged into the surroundings.

For the sake of simplicity, the fuel cell device is shown in the sketch as a single fuel cell 140. However, it goes without saying that the term fuel cell device also comprises a plurality of single cells or of fuel cell stacks which can be connected in parallel or in series. Various such interconnections of fuel cells can be used in an advantageous manner for providing different output voltages at the connections 130a, 130b so that electronic voltage conversion can be dispensed with.

The housing is implemented according to practical requirements, the position of the connections shown in the drawing being only shown by way of example. It may, for example, also be advantageous to provide, instead of a hinged cover, a completely removable cover which is secured in position by means of clamps. On the outer side of the housing, devices, such as tapped holes, can be provided by means of which the housing can be fastened reliably in laboratory shelves, a vehicle, a boat or the like. The housing can additionally be equipped with castors which allow the whole device to be displaced on level ground.

Another specially preferred use of the present invention is shown in a top view and in a sectional view in FIGS. 2A and 2B: the power supply device 200 according to the present invention is here implemented as a “business case” having a mobile-office system integrated therein.

In FIGS. 2A and 2B, features having the same function as corresponding features of the embodiment of FIGS. 1A and 1B, or a function which is comparable to the function of said corresponding features, are designated by reference numerals that have been augmented by 100. For example, reference numeral 210 stands for the case housing, 211 for the carrying handle, etc.

The case housing 210 has provided therein fixedly installed fuel cell devices 240 and, additionally, replaceable fuel cartridges 220 for supplying said fuel cell devices with fuel.

For supplying the fuel cell(s) with oxygen, the case wall has provided therein openings 215 (e.g. slots or holes) through which air can be supplied to the fuel cell. Ventilators, which are operated with the current produced, can support the supply of air. The openings 215 are protected against contamination of the supplied air (e.g. by filters), and they are arranged such that a clogging of openings is unlikely and that, in particular, simultaneous clogging of all openings can be excluded as far as possible, so that the function of clogged openings can easily be taken over by the openings which are still capable of operating.

The case interior is preferably hermetically sealed from its surroundings so that fuel escaping in the case of a defect will not reach the surroundings.

Since the operability of a fuel cell device normally depends on the position of said device relative to the gravity effect, it will be expedient to implement the outer shape of the case housing such that the case cannot easily be put down in a position in which the function of the fuel cell device(s) is impaired. This can be achieved by a suitable selection of the centre of gravity, by rounded portions, etc.

Alternatively, a plurality of fuel cell devices can be arranged in said case in such a way that at least one fuel cell device will be capable of functioning at any position, or at least at any plausible position. Simultaneously, these fuel cell devices can be controlled by a control unit such that precisely one fuel cell device will be in operation at any position.

In addition, an electric security system 260 can be integrated, which can be supplied with power via the fuel cell(s) as well. This security system can be implemented such that, if the case should be stolen, it will be possible to locate it and/or to trigger an alarm, or to render the content or part of the content unserviceable. Alternatively or additionally, an active lock system can be integrated, which allows the user to open the case without a key or a number combination (keyless-open/keyless-go). Like the electric security system 260, also the active lock system is supplied with power via the fuel cells.

Depending on the respective structural design and the field of use, it may be expedient to implement the device such that the replaceable fuel cartridge(s) provided for supplying the fuel cell can be replaced in the open or in the closed condition of the case.

Plug-in places for various pieces of office equipment, such as a laptop 251, a mobile phone 252, a satellite telephone 253, and for other devices—which are not shown in the sketch—such as a video camera, a digital camera, a printer, a fax machine, PDA, a dictation set, radio and/or television sets, a lamp, a charging set (e.g. for electric shavers), navigation units, are additionally provided in the interior of the case.

The fuel cell devices 240 can be used for directly supplying the power for operating the units connected thereto or for charging the accumulators of said units.

According to a particularly advantageous embodiment, the case is provided with a control means with intelligent power management which detects the operating condition and/or state of charge of the units connected thereto and controls the power supply in accordance with this condition/state. If desired, a hierarchy of the units which are connected or which are adapted to be connected can be predetermined for this control.

The plug-in places for mechanical mounting may comprise electric interfaces so that the contact between the respective unit and the power supply will be closed when the unit is being positioned in the case.

In addition or alternatively to electric interfaces at the plug-in places, it may be of advantage to provide a possibility of establishing the electric connection via cable connections. For this purpose, flexible cables are preferably used, which permit the connected units to be removed from the case without interrupting the power supply.

Another preferred embodiment comprises plug-in places for respective units also on the outer surface of the housing. In the case of a desktop configuration, for example, a laptop can be connected to a mechanical and electric interface on the outer surface of the case and used in this condition. A mechanical/electric plug-in place on the outer surface is also advantageous for units which must be ready to hand or which are frequently used, as may e.g. be the case with mobile phones.

In particular, as has already been described in connection with the embodiment according to FIGS. 1A, 1B, also the business case 200 may be provided with connecting sockets in the case housing 210; these connecting sockets allow—without opening the case—external consumers to be connected and supplied with power.

This kind of embodiment allows a further advantageous use of the invention, which is shown in the sketch in FIG. 3. In the case of this advantageous use, the devices 100, 200 according to the present invention are used for supplying power to a whole system of cases comprising a power-supply device 300 (e.g. the chest according to FIG. 1 or the case according to FIG. 2) and plurality of business cases 300′ connected thereto.

These business cases 300′ differ from the business case 200 shown in FIGS. 2A, 2B insofar as they do not (necessarily) have a fuel cell device 340 of their own and are supplied with power by the power-supply device 300 via interconnection lines 335.

1. A housing for a mobile power supply device, wherein:
at least one housing section is provided for accommodating at least one fuel cell device,
at least one housing section is provided for accommodating at least one electric consumer, and
at least one housing section is provided for installing a fuel tank or for insertion of a replaceable fuel cartridge.

2. A housing according to claim 1, wherein said housing has a connection for supplying fuel from outside.

3. A housing according to claim 1, comprising at least one plug-in place for mechanically mounting the at least one electric consumer.

4. A housing according to claim 1, comprising at least one electric interface for connection of the at least one electric consumer.

5. A housing according to claim 4, wherein the at least one electric interface is formed integrally with a plug-in place.

6. A housing according to claim 1, comprising an active security system and/or an active lock system.

7. A housing according to claim 1, which is implemented in the form of a case or a chest.

8. A housing according to claim 1, comprising at least one electric interface on the outer surface of the housing.

9. A mobile power supply device, comprising:
a housing according to claim 1 and
at least one fuel cell device provided in said housing.

10. A mobile power supply device according to claim 9, comprising:
a control means for controlling the power supply of electric consumers connected to said power supply device.

11. A mobile power supply device according to claim 10, wherein at least one fuel cell device comprises a direct methanol fuel cell.

12. A mobile power supply device according to claim 9, wherein:
the housing is implemented such and the at least one fuel cell device is arranged in said housing such that the operability of the at least one fuel cell device is guaranteed in at least one stable preferred position of said housing, or wherein
the at least one fuel cell device is arranged in the housing in such a way that it occupies a position having an orientation which depends on the position of the housing and which guarantees the operability of said fuel cell device at any position of the housing, or wherein
a plurality of fuel cell devices is arranged in said housing such that the operability of at least one fuel cell device is guaranteed at any position of the housing.

13. A mobile power supply system, comprising:
a mobile power supply device according to claim 1, and
at least one distribution unit for connecting electric consumers, said distribution unit being adapted to be connected to an electric interface of the mobile power supply device via an external line.

14. A mobile power supply device according to claim 10, wherein:
the housing is implemented such and the at least one fuel cell device is arranged in said housing such that the operability of the at least one fuel cell device is guaranteed in at least one stable preferred position of said housing, or wherein
the at least one fuel cell device is arranged in the housing in such a way that it occupies a position having an orientation which depends on the position of the housing and which guarantees the operability of said fuel cell device at any position of the housing, or wherein
a plurality of fuel cell devices is arranged in said housing such that the operability of at least one fuel cell device is guaranteed at any position of the housing.

15. A mobile power supply device according to claim 11, wherein:
the housing is implemented such and the at least one fuel cell device is arranged in said housing such that the operability of the at least one fuel cell device is guaranteed in at least one stable preferred position of said housing, or wherein
the at least one fuel cell device is arranged in the housing in such a way that it occupies a position having an orientation which depends on the position of the housing and which guarantees the operability of said fuel cell device at any position of the housing, or wherein
a plurality of fuel cell devices is arranged in said housing such that the operability of at least one fuel cell device is guaranteed at any position of the housing.

16. A mobile power supply system, comprising:
a mobile power supply device according to claim 2, and
at least one distribution unit for connecting electric consumers, said distribution unit being adapted to be connected to an electric interface of the mobile power supply device via an external line.

17. A mobile power supply system, comprising:
a mobile power supply device according to claim 3, and
at least one distribution unit for connecting electric consumers, said distribution unit being adapted to be connected to an electric interface of the mobile power supply device via an external line.

18. A mobile power supply system, comprising:
a mobile power supply device according to claim 4, and
at least one distribution unit for connecting electric consumers, said distribution unit being adapted to be connected to an electric interface of the mobile power supply device via an external line.

19. A mobile power supply system, comprising:
a mobile power supply device according to claim 6, and
at least one distribution unit for connecting electric consumers, said distribution unit being adapted to be connected to an electric interface of the mobile power supply device via an external line.

20. A mobile power supply system, comprising:
a mobile power supply device according to claim 7, and
at least one distribution unit for connecting electric consumers, said distribution unit being adapted to be connected to an electric interface of the mobile power supply device via an external line.
